(19) United States
(12) Patent Application Publication
(10) Pub. No.: US 2022/0290746 A1
(43) Pub. Date: Sep. 15, 2022

(54) TRANSMISSION WITH AVERAGING DIFFERENTIAL

(71) Applicant: Joel SULLIVAN, Nova Scotia (CA)

(72) Inventor: Joel SULLIVAN, Nova Scotia (CA)

(21) Appl. No.: 17/634,323

(22) PCT Filed: Aug. 7, 2020
(86) PCT No.: PCT/CA2020/000097

§ 371 Date: Feb. 10, 2022

(30) Foreign Application Priority Data
Aug. 16, 2019 (CA) 3052386

(51) Int. Cl. F16H 37/08

(52) U.S. Cl. CPC F16H 37/0833

(57) ABSTRACT

A transmission comprising an input shaft for being connected to an engine for receiving power therefrom. At least two input gear wheels are disposed along the input shaft. At least two intermediate gear wheels are disposed along each of at least two intermediate shafts such that each input gear wheel is associated with a respective intermediate gear wheel. A clutch system selectively activates input-intermediate gear wheel combinations for transmitting the power such that at least one of the input gear wheels and at least one intermediate gear wheel is activated. An averaging differential is connected to the intermediate shafts and to an output shaft, the averaging differential combines the power received from the intermediate shafts and provides the same to the output shaft.

This application is a national stage filing of International (PCT) Application No. PCT/CA2020/000097, filed on Aug. 7, 2020 (corresponding to Publication No. WO 2021/030898) and entitled Transmission With Averaging Differential, which in turn claims priority to Canadian Patent Application No. 3,052,386, filed on Aug. 16, 2019. The entire contents of both of these applications are incorporated by reference herein.

### FIELD

The present invention relates to transmissions having multiple gear ratios, and more particularly to a transmission with an averaging differential having high gear ratios and a large number of gear ratios.

### BACKGROUND

Present-day vehicle transmissions having multiple gear ratios typically belong to one of three categories: manual transmissions; automatic transmissions; and Continuously Variable Transmissions (CTV)s.

Manual transmissions are robust, relatively simple, and cost effective to manufacture. However, manual transmissions typically require a friction clutch being interposed between the manual transmission and the engine for disconnecting the same from the engine while shifting gears, resulting in relatively slow shifting between gears. To enable fast shifting, double clutch transmissions are employed in sports cars, which are prone to burning up in stop and go traffic.

Automatic transmissions obviate the use of a friction clutch, thus enabling fast shifting. However, automatic transmissions require complex precision machined components and are, therefore, substantially more expensive to manufacture than manual transmissions.

CTVs enable fast continuous shifting between gears, but are relatively fragile and typically not suited for applications involving high torque such as, for example, in transmissions for large trucks.

Size constraints in order to fit the transmission into a vehicle such as, for example, a car or a truck, substantially limit the number of gear ratios provided by manual and automatic transmissions to typically 7 to 9.

Furthermore, the size constraints also limit the gear ratios itself provided by manual and automatic transmissions, as well as CTVs, to typically 7:1 as the upper limit. In order to achieve higher gear ratios, for example, 50:1, additional gearing is provided in the transfer case of trucks.

It may be desirable to provide a transmission that is compact in size yet capable of providing a large number of gear ratios, as well as high gear ratios.

It also may be desirable to provide a transmission that is sufficiently robust for high torque applications.

It also may be desirable to provide a transmission that is simple and cost-effective to manufacture.

### SUMMARY

Accordingly, in one case the present invention may provide a transmission that is compact in size yet capable of providing a large number of gear ratios, as well as high gear ratios.

In another case the present invention may provide a transmission that is sufficiently robust for high torque applications.

In another case the present invention may provide a transmission that is simple and cost-effective to manufacture.

According to one aspect of the present invention, there is provided a transmission. The transmission comprises an input shaft for being connected to an engine for receiving power therefrom. At least two input gear wheels are disposed along the input shaft. At least two intermediate gear wheels are disposed along each of at least two intermediate shafts such that each input gear wheel is associated with a respective intermediate gear wheel. A clutch system selectively activates input-intermediate gear wheel combinations for transmitting the power such that at least one of the input gear wheels and at least one intermediate gear wheel is activated. An averaging differential is connected to the intermediate shafts and to an output shaft, the averaging differential combines the power received from the intermediate shafts and provides the same to the output shaft.

According to one aspect of the present invention, there is provided a method for selectively transmitting power. The power is received from an engine at an input shaft. The power is then selectively transmitted to at least two intermediate shafts. Using an averaging differential connected to the intermediate shafts and to an output shaft the power received from the intermediate shafts is combined and provided to the output shaft.

An advantage of the present invention is that it may provide a transmission that is compact in size yet capable of providing a large number of gear ratios, as well as high gear ratios.

A further advantage of the present invention is that it may provide a transmission that is sufficiently robust for high torque applications.

A further advantage of the present invention is that it may provide a transmission that is simple and cost-effective to manufacture.

### BRIEF DESCRIPTION OF THE DRAWINGS

An embodiment of the present invention is described below with reference to the accompanying drawings, in which:

FIG. 1 is a simplified block diagram illustrating in a cross sectional view a transmission according to an embodiment of the invention;

FIG. 2a is a simplified block diagram illustrating in cross sectional view an activated gear ratio of the transmission according to an embodiment of the invention;

FIG. 2b is a simplified block diagram illustrating in cross sectional view an activated gear ratio of the transmission according to an embodiment of the invention;

FIG. 2c is a simplified block diagram illustrating in cross sectional view an activated gear ratio of the transmission according to an embodiment of the invention;

FIG. 2d is a simplified block diagram illustrating in cross sectional view an activated gear ratio of the transmission according to an embodiment of the invention;

FIG. 2e is a simplified block diagram illustrating in cross sectional view an activated gear ratio of the transmission according to an embodiment of the invention;

FIG. 2f is a simplified block diagram illustrating in cross sectional view an activated gear ratio of the transmission according to an embodiment of the invention;

FIG. 2g is a simplified block diagram illustrating in cross sectional view an activated gear ratio of the transmission according to an embodiment of the invention;

FIG. 2h is a simplified block diagram illustrating in cross sectional view an activated gear ratio of the transmission according to an embodiment of the invention;

FIG. 2i is a simplified block diagram illustrating in cross sectional view an activated gear ratio of the transmission according to an embodiment of the invention;

FIG. 3 is a simplified block diagram illustrating in a cross sectional view a transmission according to another embodiment of the invention;

FIG. 4 is a simplified block diagram illustrating in a cross sectional view a transmission according to yet another embodiment of the invention;

FIGS. 5a and 5b are simplified block diagrams illustrating in cross sectional views two implementations of a transmission according to yet another embodiment of the invention;

FIG. 6a is a simplified block diagram illustrating in cross sectional view an activated gear ratio of the transmission according to an embodiment of the invention illustrated in FIG. 5a;

FIG. 6b is a simplified block diagram illustrating in cross sectional view an activated gear ratio of the transmission according to an embodiment of the invention illustrated in FIG. 5a;

FIG. 6c is a simplified block diagram illustrating in cross sectional view an activated gear ratio of the transmission according to an embodiment of the invention illustrated in FIG. 5a;

FIG. 6d is a simplified block diagram illustrating in cross sectional view an activated gear ratio of the transmission according to an embodiment of the invention illustrated in FIG. 5a;

FIG. 6e is a simplified block diagram illustrating in cross sectional view an activated gear ratio of the transmission according to an embodiment of the invention illustrated in FIG. 5a;

FIG. 6f is a simplified block diagram illustrating in cross sectional view an activated gear ratio of the transmission according to an embodiment of the invention illustrated in FIG. 5a;

FIGS. 7a and 7b are simplified block diagrams illustrating in sectional views two implementations of the transmission according to an embodiment of the invention illustrated in FIG. 1;

FIG. 8 is a simplified block diagram illustrating in a sectional view a transmission according to yet another embodiment of the invention; and,

FIG. 9 is a simplified block diagram illustrating in a sectional view a transmission control system according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to a transmission for use in a vehicle such as a car or a truck, it will become evident to those skilled in the art that the embodiments of the invention are not limited thereto, but are also adaptable for various other vehicles such as, for example, locomotives and construction vehicles, as well as for stationary applications such as, for example, large compressors.

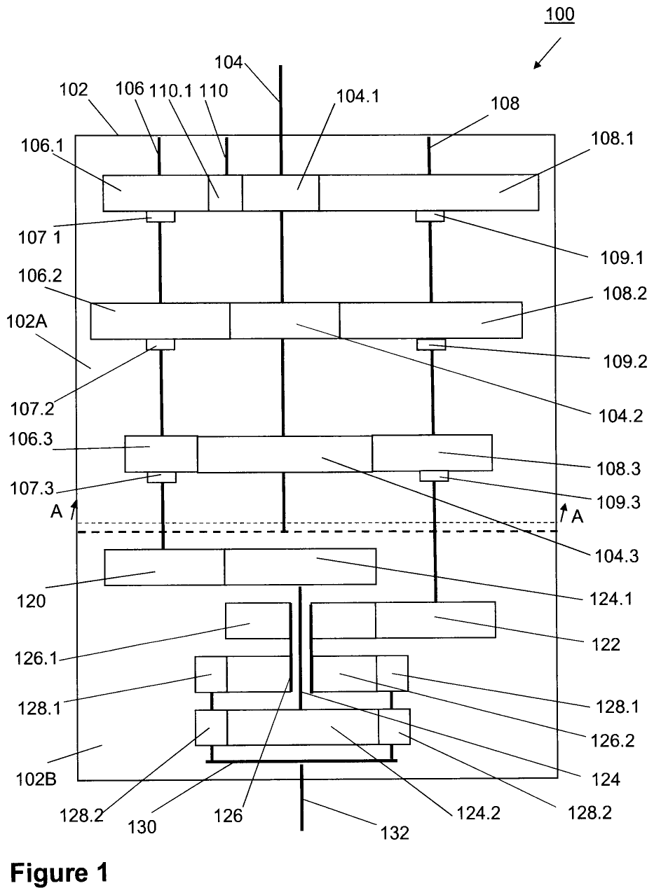

Referring to FIG. 1 a transmission 100 according to an embodiment of the invention is provided. The transmission 100 comprises a housing 102 enclosing a gear section 102A and a differential section 102B. Input shaft 104, adapted for being connected to an engine, and intermediate shafts 106 and 108 are rotatably movable mounted in a conventional manner to the housing 102 and shaft support structure 102C. Input gear wheels 104.1, 104.2, and 104.3 such as, for example, conventional helical gear wheels, are disposed along the input shaft 104 and mounted thereto in a conventional manner. Intermediate gear wheels 106.1, 106.2, and 106.3 are disposed along the intermediate shaft 106 and intermediate gear wheels 108.1, 108.2, and 108.3 are disposed along the intermediate shaft 108 such that each input gear wheel is associated with a respective intermediate gear wheel of each of the intermediate shafts 106 and 108.

The intermediate gear wheels 106.1, 106.2, and 106.3 are selectively connected to the intermediate shaft 106 via clutches 107.1, 107.2, and 107.3 and intermediate gear wheels 108.1, 108.2, and 108.3 are selectively connected to the intermediate shaft 108 via clutches 109.1, 109.2, and 109.3. The clutches enable selectively activating input-intermediate gear wheel combinations for transmitting the power received from the engine such that at least one of the input gear wheels and one intermediate gear wheel of each intermediate shaft is activated, as will be described in more detail hereinbelow. The clutches can be conventional multi-plate wet clutches, which are hydraulically activated in a conventional manner. Alternatively, other types of clutches may be employed such as, for example, conventional positively engaged dog clutches or a combination thereof.

An averaging differential is connected to the intermediate shafts 106, 108 and to output shaft 132. The averaging differential combines the power received from the intermediate shafts 106, 108 in an averaging fashion and provides the same to the output shaft 132. The averaging differential is, for example, of conventional epicyclic—or planetary—design. Output gear wheels 120 and 122 mounted to the intermediate shafts 106 and 108, respectively, interact with associated sun wheels 124.1 and 126.1 of sun wheel combinations 124.1, 124.2 and 126.1 and 126.2 of the averaging differential. Each of the sun wheels 124.2 and 126.2 interact with associated planetary wheels 128.1 and 128.2, respectively. The planetary wheels 128.1 and 128.2 are independently rotatable mounted to planetary carriage 130, which is connected to the output shaft 132.

To enable reverse rotating motion of the output shaft 132, reverse gear wheel 110.1 mounted to reverse shaft 110 is interposed between an input gear wheel and an intermediate gear wheel associated therewith such as, for example, input gear wheel 104.1 and intermediate gear wheel 106.1, as illustrated in FIG. 1.

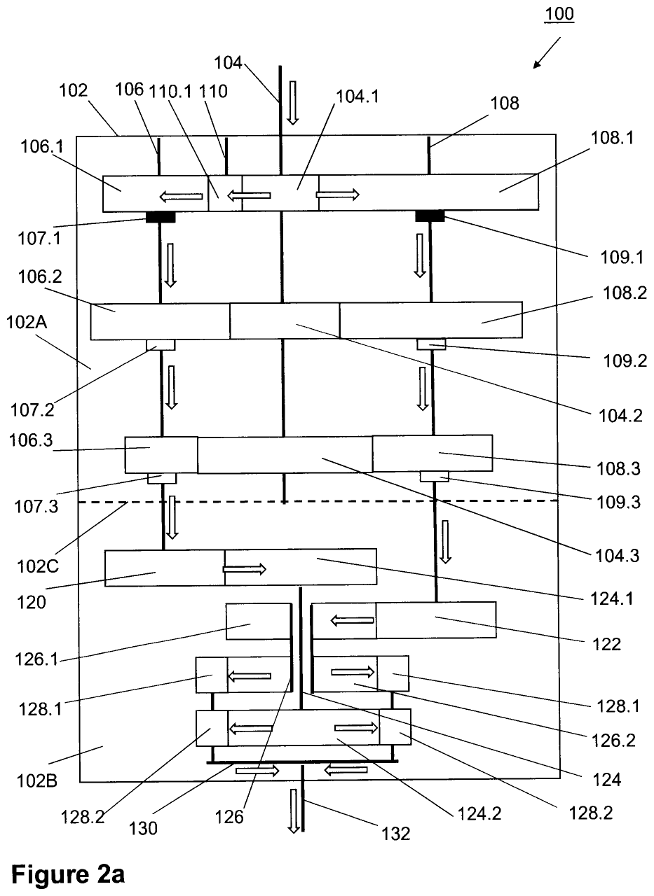

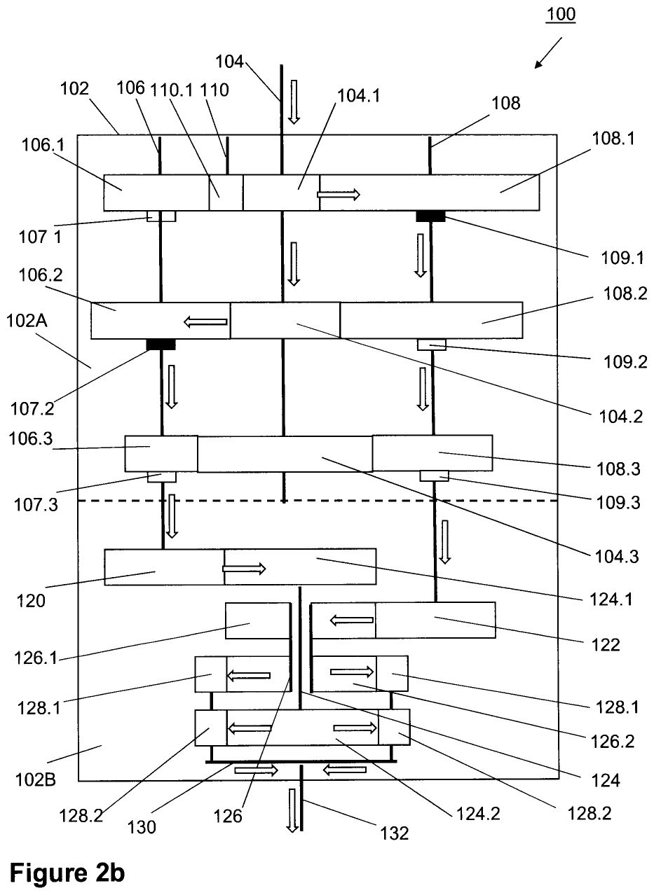

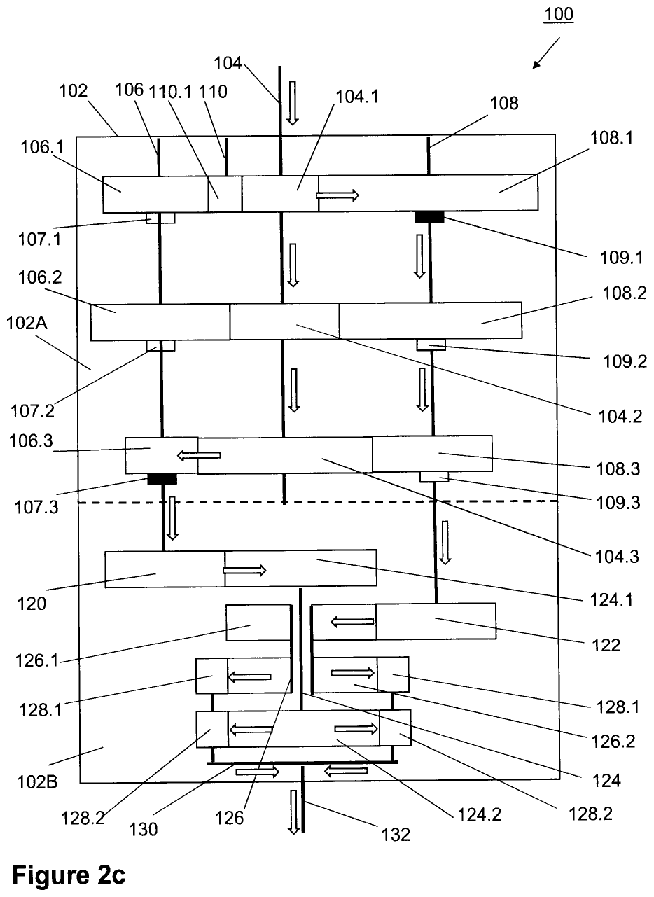

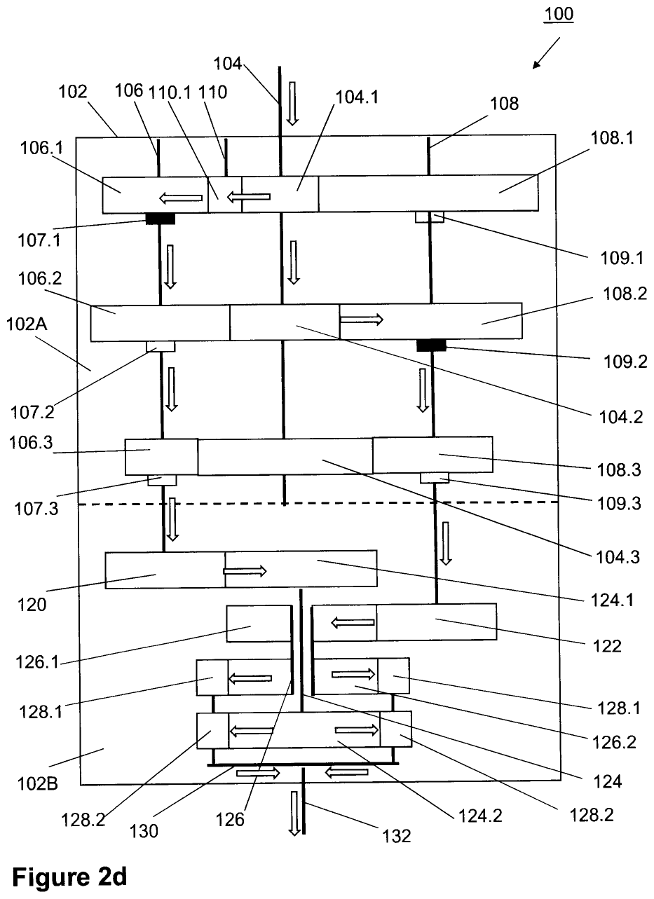

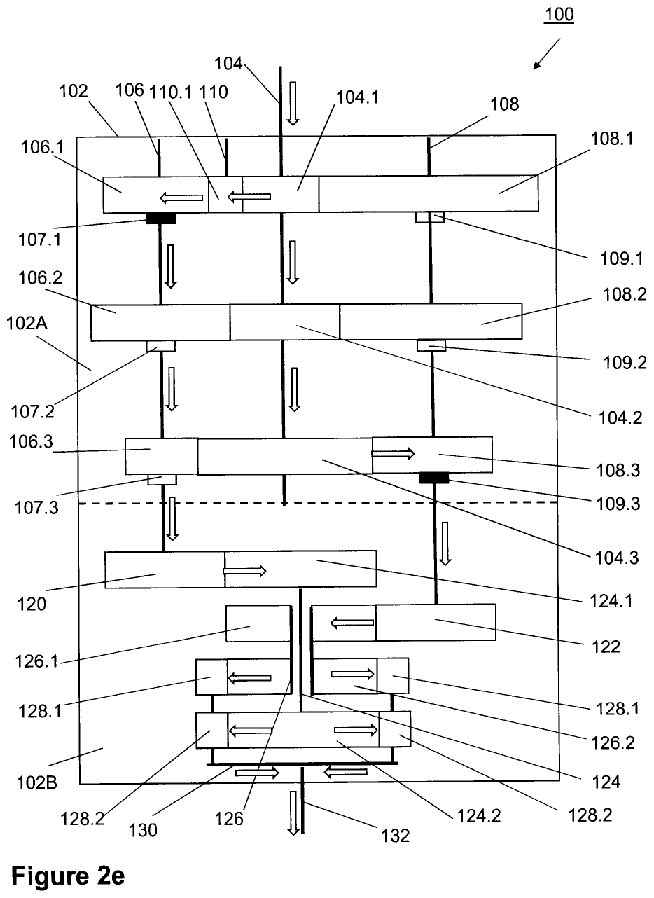

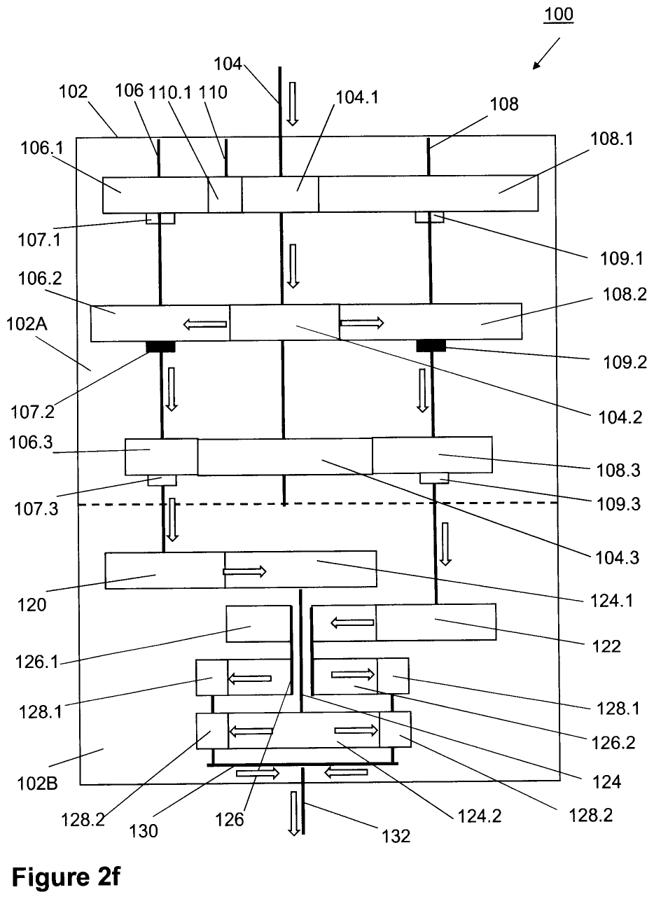

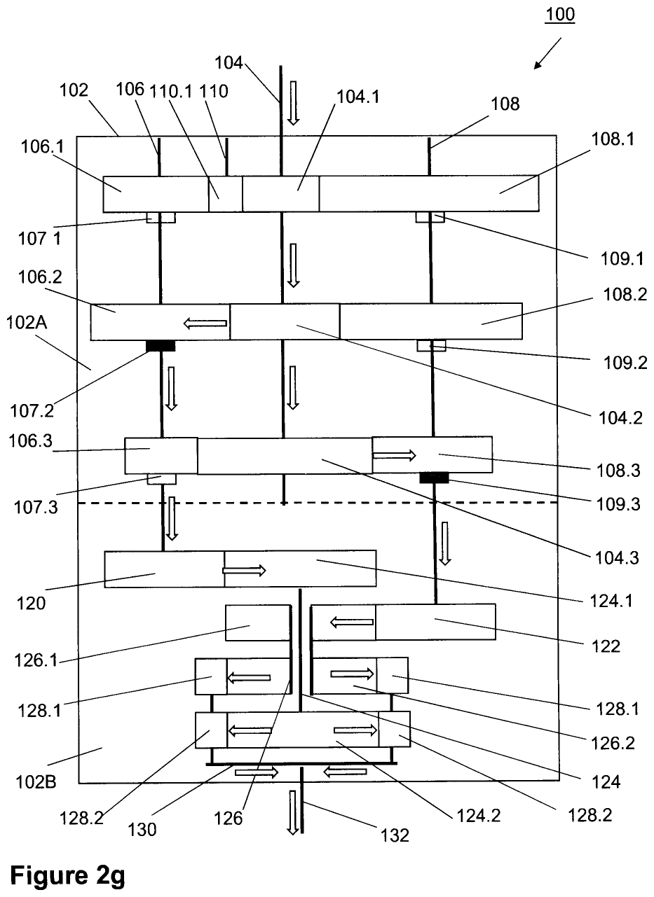

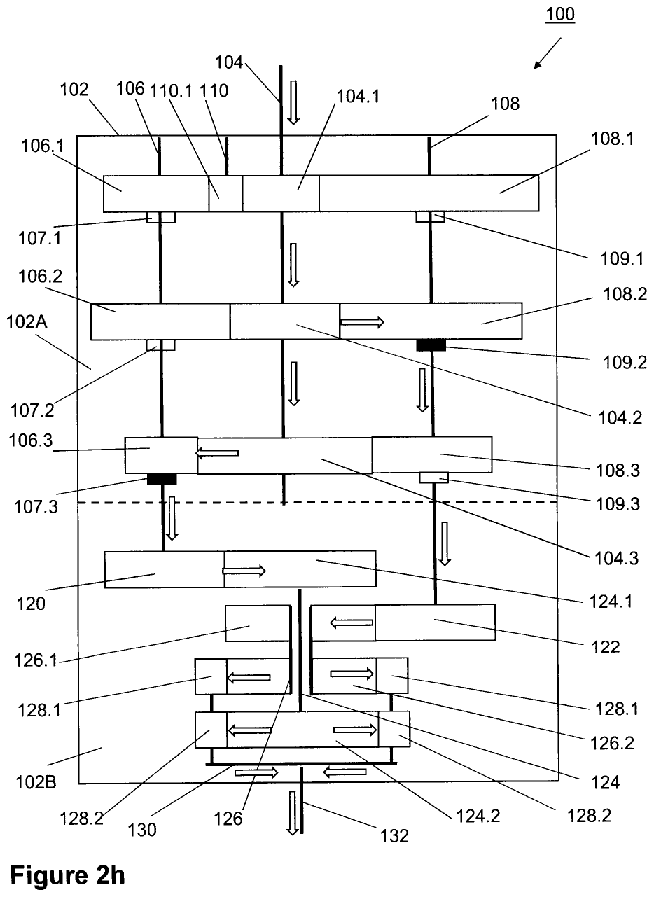

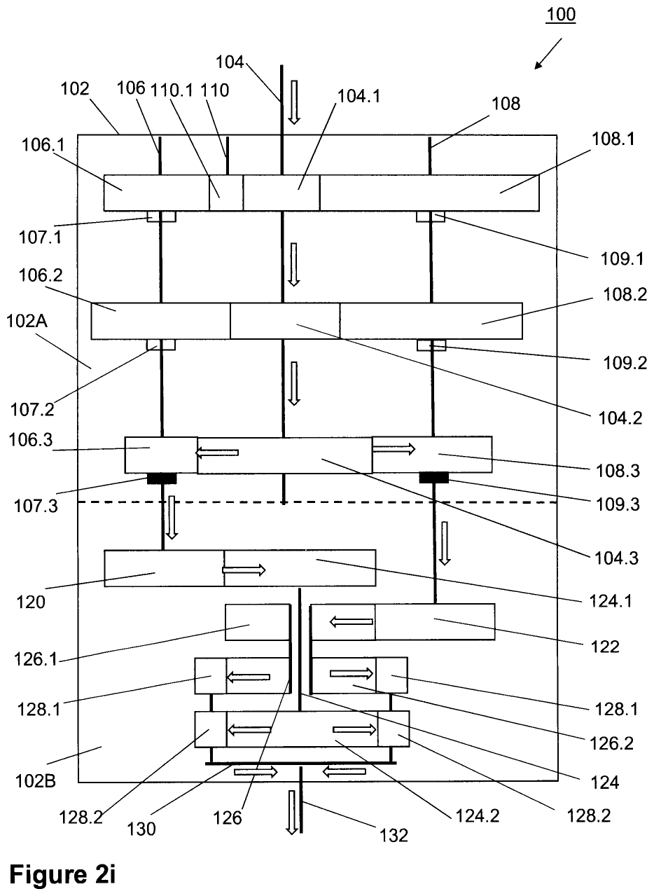

The transmission 100 enables 3×3=9 different gear ratios depending on the activation of the clutches 107.1, 107.2, 107.3, 109.1, 109.2, and 109.3 as illustrated in FIGS. 2a to 2i. In FIG. 2a clutches 107.1 and 109.1 are activated, thus connecting intermediate gear wheels 106.1 and 108.1 to the respective intermediate shafts 106 and 108 in order to transmit the power received from the engine via reverse gear wheel combination 104.1, 110.1, and 106.1 to the intermediate shaft 106 and via gear wheel combination 104.1 and 108.1 to the intermediate shaft 108, as indicated by the block arrows in FIG. 2a. The averaging differential receives the power via the sun wheels 124.1 and 126.1 from the intermediate shafts 106 and 108, respectively, and combines the same in an averaging fashion and provides the combined power to the output shaft 132, as indicated by the block arrows in FIG. 2a.

In FIG. 2b clutches 107.2 and 109.1 are activated, thus connecting intermediate gear wheels 106.2 and 108.1 to the respective intermediate shafts 106 and 108 in order to transmit the power received from the engine via gear wheel combination 104.2 and 106.2 to the intermediate shaft 106 and via gear wheel combination 104.1 and 108.1 to the intermediate shaft 108, as indicated by the block arrows in FIG. 2b.

In FIG. 2c clutches 107.3 and 109.1 are activated, thus connecting intermediate gear wheels 106.3 and 108.1 to the respective intermediate shafts 106 and 108 in order to transmit the power received from the engine via gear wheel combination 104.3 and 106.3 to the intermediate shaft 106 and via gear wheel combination 104.1 and 108.1 to the intermediate shaft 108, as indicated by the block arrows in FIG. 2c.

In FIG. 2d clutches 107.1 and 109.2 are activated, thus connecting intermediate gear wheels 106.1 and 108.2 to the respective intermediate shafts 106 and 108 in order to transmit the power received from the engine via reverse gear wheel combination 104.1, 110.1, and 106.1 to the intermediate shaft 106 and via gear wheel combination 104.2 and 108.2 to the intermediate shaft 108, as indicated by the block arrows in FIG. 2d.

In FIG. 2e clutches 107.1 and 109.3 are activated, thus connecting intermediate gear wheels 106.1 and 108.3 to the respective intermediate shafts 106 and 108 in order to transmit the power received from the engine via reverse gear wheel combination 104.1, 110.1, and 106.1 to the intermediate shaft 106 and via gear wheel combination 104.3 and 108.3 to the intermediate shaft 108, as indicated by the block arrows in FIG. 2e.

In FIG. 2f clutches 107.2 and 109.2 are activated, thus connecting intermediate gear wheels 106.2 and 108.2 to the respective intermediate shafts 106 and 108 in order to transmit the power received from the engine via gear wheel combination 104.2 and 106.2 to the intermediate shaft 106 and via gear wheel combination 104.2 and 108.2 to the intermediate shaft 108, as indicated by the block arrows in FIG. 2f.

In FIG. 2g clutches 107.2 and 109.3 are activated, thus connecting intermediate gear wheels 106.2 and 108.3 to the respective intermediate shafts 106 and 108 in order to transmit the power received from the engine via gear wheel combination 104.2 and 106.2 to the intermediate shaft 106 and via gear wheel combination 104.3 and 108.3 to the intermediate shaft 108, as indicated by the block arrows in FIG. 2g.

In FIG. 2h clutches 107.3 and 109.2 are activated, thus connecting intermediate gear wheels 106.3 and 108.2 to the respective intermediate shafts 106 and 108 in order to transmit the power received from the engine via gear wheel combination 104.3 and 106.3 to the intermediate shaft 106 and via gear wheel combination 104.2 and 108.2 to the intermediate shaft 108, as indicated by the block arrows in FIG. 2h.

In FIG. 2i clutches 107.3 and 109.3 are activated, thus connecting intermediate gear wheels 106.3 and 108.3 to the respective intermediate shafts 106 and 108 in order to transmit the power received from the engine via gear wheel combination 104.3 and 106.3 to the intermediate shaft 106 and via gear wheel combination 104.3 and 108.3 to the intermediate shaft 108, as indicated by the block arrows in FIG. 2i.

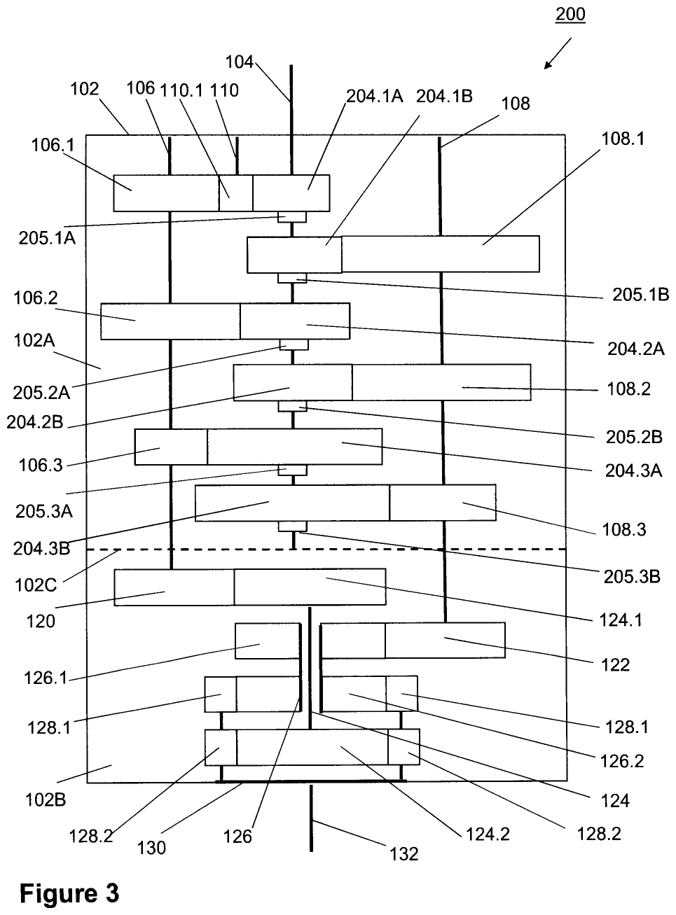

Referring to FIG. 3, a transmission 200 according to another embodiment of the invention is provided. Same reference numerals are used to refer to same components as in the transmission 100. In the transmission 200 the input gear wheels 104.1, 104.2, and 104.3 of transmission 100 are replaced by respective pairs of input gear wheels 204.1A, 204.1B, 204.2A, 204.2B, 204.3A, and 204.3B with respective clutches 205.1A, 205.1B, 205.2A, 205.2B, 205.3A, and 205.3B for selectively connecting the input gear wheels 204.1A, 204.1B, 204.2A, 204.2B, 204.3A, and 204.3B to the input shaft. The clutches enable selectively activating input-intermediate gear wheel combinations for transmitting the power received from the engine such that two of the input gear wheels and one intermediate gear wheel of each intermediate shaft is activated, as will be described in more detail hereinbelow. The clutches can be conventional multi-plate wet clutches, which are hydraulically activated in a conventional manner. Alternatively, other types of clutches may be employed such as, for example, conventional positively engaged dog clutches or a combination thereof. The input gear wheels of each pair of input gear wheels may be of same size or different size. Employment of different sized input gear wheels increases the design flexibility to achieve desired gear ratios compared to the transmission 100 while the employment of pairs of input gear wheels increases the length of the transmission 200 compared to the length of the transmission 100.

As the transmission 100, the transmission 200 enables 3×3=9 different gear ratios, here depending on the activation of the clutches 205.1A, 205.1B, 205.2A, 205.2B, 205.3A, and 205.3B in a similar fashion as illustrated hereinabove in FIGS. 2a to 2i.

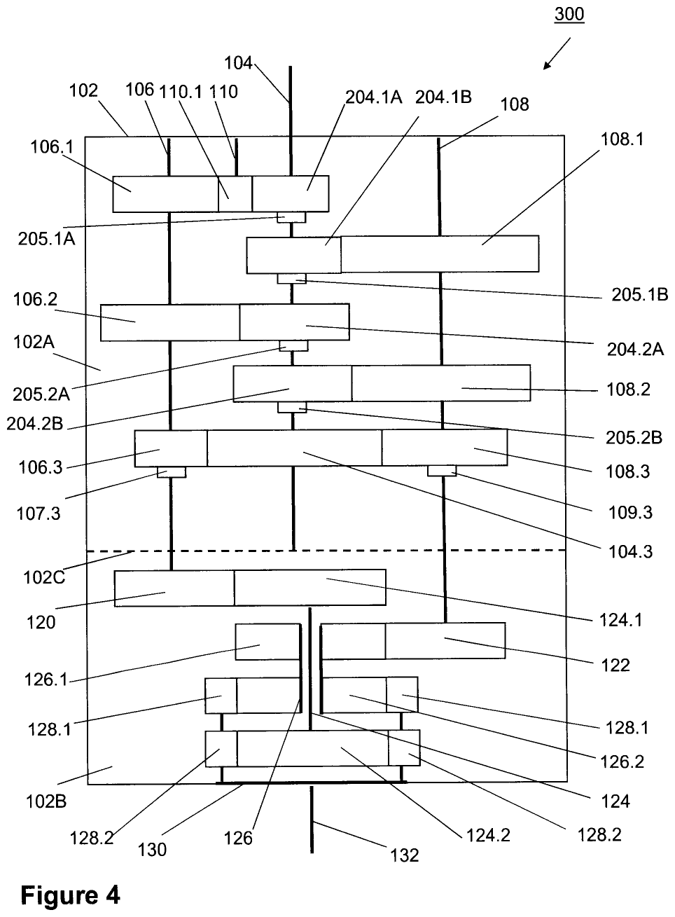

Referring to FIG. 4, a transmission 300 according to another embodiment of the invention is provided. Same reference numerals are used to refer to same components as in the transmissions 100 and 200. The transmission 300 is a combination of the transmissions 100 and 200 here, for example, with pairs of input gear wheels 204.1A, 204.1B, 204.2A, and 204.2B with respective clutches 205.1A, 205.1B, 205.2A, and 205.2B, 205.3A and a single input gear wheel 104.3 and clutches 107.3 and 109.3 selectively connecting intermediate gear wheels 106.3 and 108.3 to the respective intermediate shafts 106 and 108. This embodiment may be employed to avoid placement of a clutch in combination with a gear wheel for transmitting high torque, reducing wear of the clutch or enable use of a smaller sized clutch.

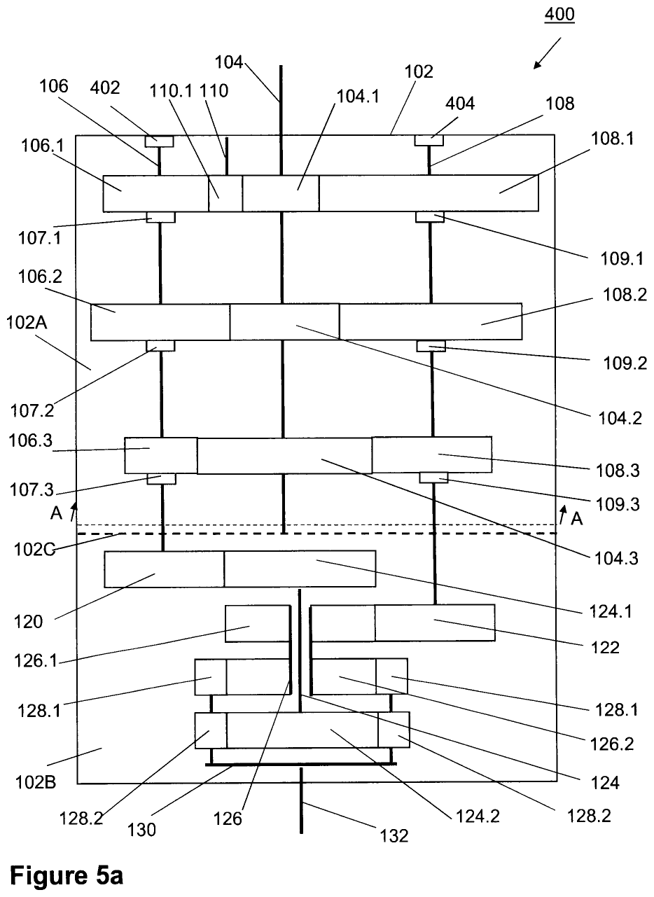

Referring to FIGS. 5a and 5b, a transmission 400 according to another embodiment of the invention is provided. Same reference numerals are used to refer to same components as in the transmission 100. Compared to the transmission 100, the transmission 400 comprises additional clutches 402 and 404 for selectively connecting the respective intermediate shafts 106 and 108 to the housing 102, as illustrated in FIG. 5a. Alternatively, additional clutches 406 and 408 are provided for selectively connecting the respective intermediate shafts 106 and 108 to the shaft support structure 102C, as illustrated in FIG. 5b. The clutches 402 and 404 or 406 and 408 enable selectively locking one of the intermediate shafts 106 and 108 for selectively activating additional input-intermediate gear wheel combinations for transmitting the power received from the engine such that one of the input gear wheels and one intermediate gear wheel of an un-blocked intermediate shaft is activated, as will be described in more detail hereinbelow. The clutches 402, 404, 406, and 408 can be conventional multi-plate wet clutches, which are hydraulically activated in a conventional manner. Alternatively, other types of clutches may be employed such as, for example, conventional positively engaged dog clutches or a combination thereof.

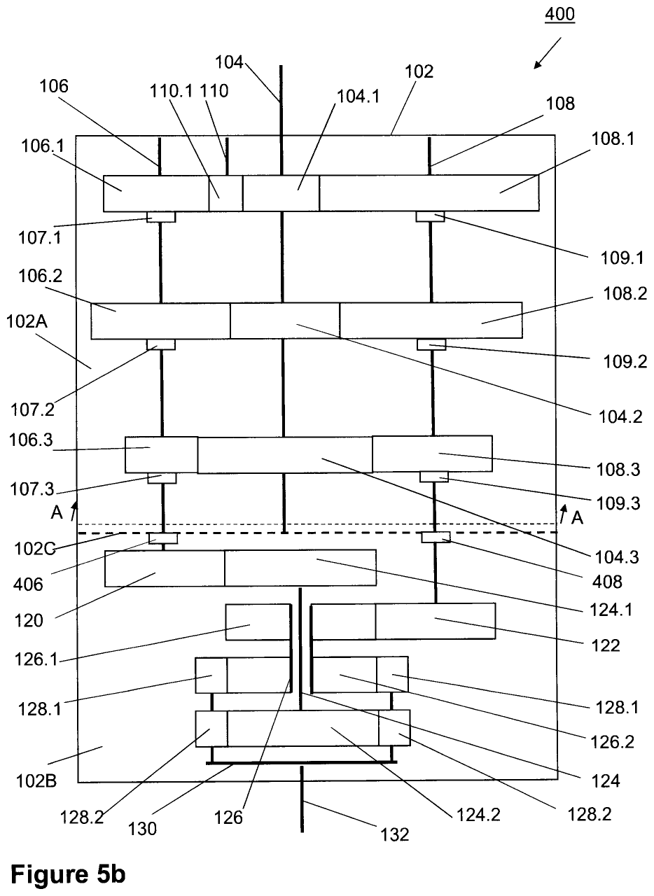

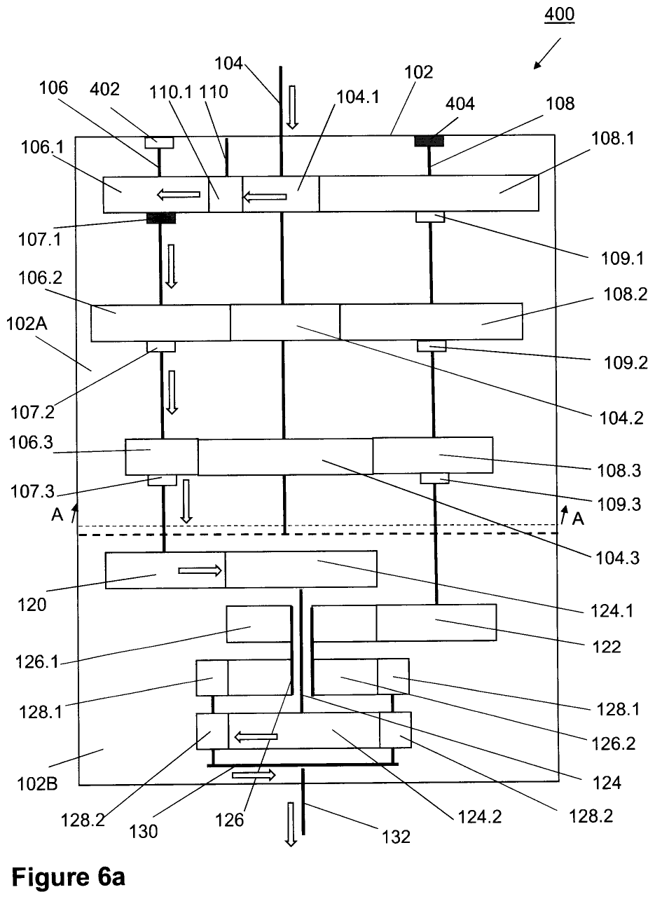

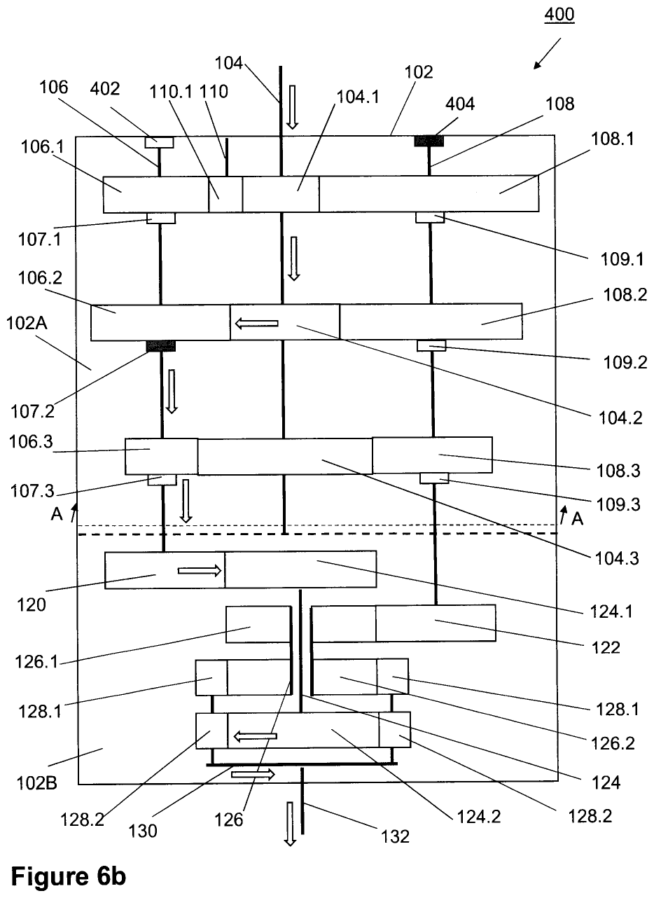

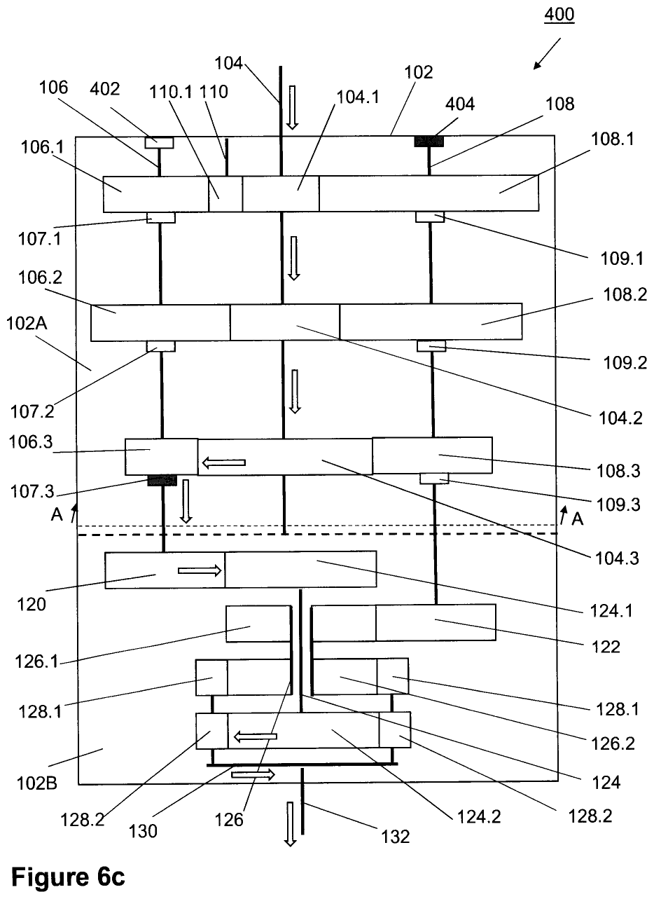

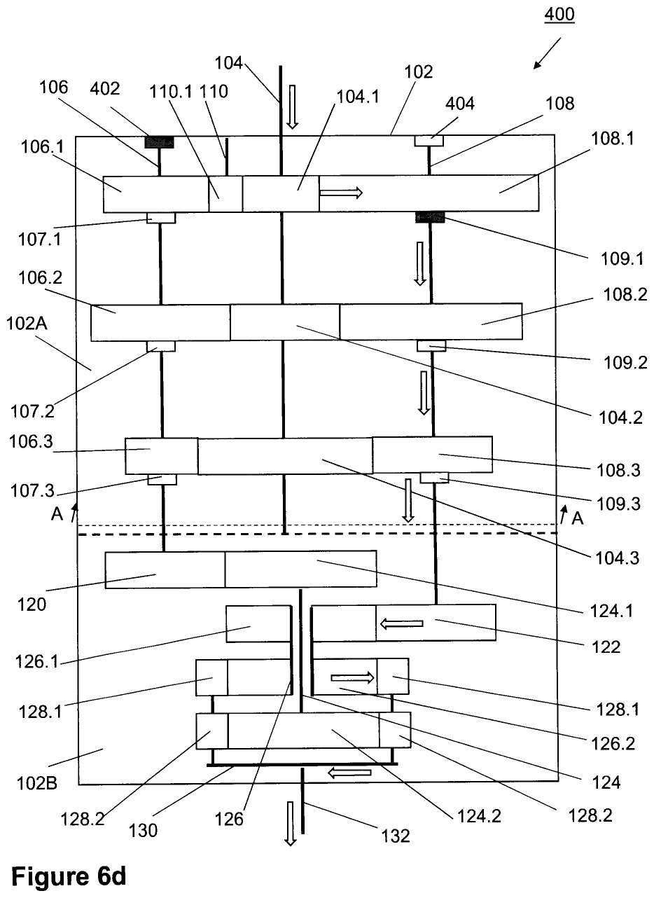

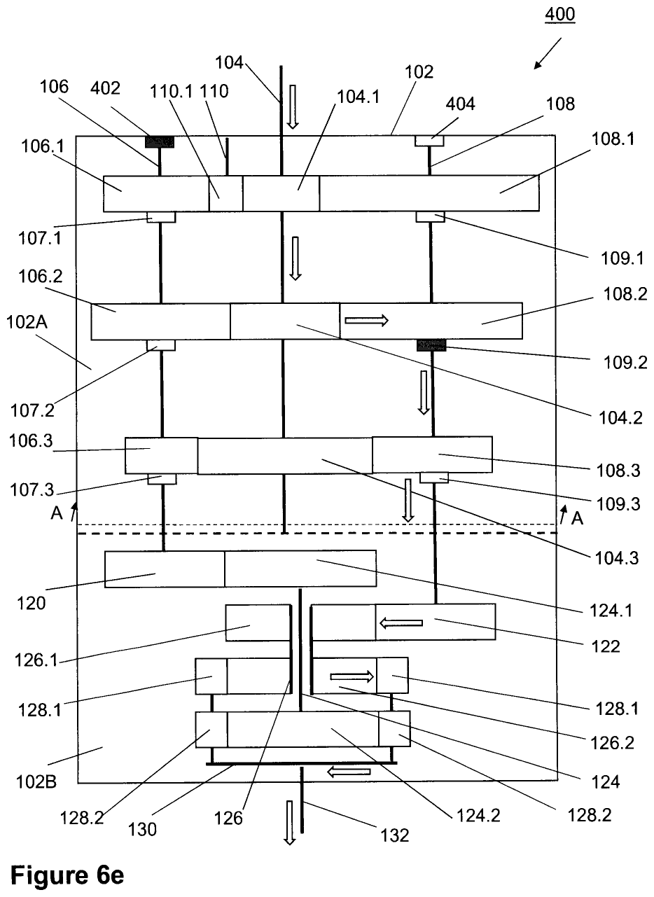

The transmission 400 enables 3+3=6 additional different gear ratios to the 9 gear ratios of the transmission 100 depending on the activation of the clutches 402, 404, 107.1, 107.2, 107.3, 109.1, 109.2, and 109.3 as illustrated in FIGS. 6a to 6f. In FIG. 6a clutches 107.1 and 404 are activated, thus connecting intermediate gear wheel 106.1 to the respective intermediate shaft 106 in order to transmit the power received from the engine via reverse gear wheel combination 104.1, 110.1, and 106.1 to the intermediate shaft 106, as indicated by the block arrows in FIG. 6a. The averaging differential receives the power via the sun wheel 124.1 from the intermediate shaft 106 and provides the same to the output shaft 132, as indicated by the block arrows in FIG. 6a, while the activated clutch 404 prevents the intermediate shaft 108 and the sun wheel 126.1 from ‘freewheeling’.

In FIG. 6b clutches 107.2 and 404 are activated, thus connecting intermediate gear wheel 106.2 to the respective intermediate shaft 106 in order to transmit the power received from the engine via gear wheel combination 104.2 and 106.2 to the intermediate shaft 106, as indicated by the block arrows in FIG. 6b.

In FIG. 6c clutches 107.3 and 404 are activated, thus connecting intermediate gear wheel 106.3 to the respective intermediate shaft 106 in order to transmit the power received from the engine via gear wheel combination 104.3 and 106.3 to the intermediate shaft 106, as indicated by the block arrows in FIG. 6c.

In FIG. 6d clutches 109.1 and 402 are activated, thus connecting intermediate gear wheel 108.1 to the respective intermediate shaft 108 in order to transmit the power received from the engine via gear wheel combination 104.1 and 108.1 to the intermediate shaft 108, as indicated by the block arrows in FIG. 6d. The averaging differential receives the power via the sun wheel 126.1 from the intermediate shaft 108 and provides the same to the output shaft 132, as indicated by the block arrows in FIG. 6d, while the activated clutch 402 prevents the intermediate shaft 106 and the sun wheel 124.1 from ‘freewheeling’.

In FIG. 6e clutches 109.2 and 402 are activated, thus connecting intermediate gear wheel 108.2 to the respective intermediate shaft 108 in order to transmit the power received from the engine via gear wheel combination 104.2 and 108.2 to the intermediate shaft 108, as indicated by the block arrows in FIG. 6e.

In FIG. 6f clutches 109.3 and 402 are activated, thus connecting intermediate gear wheel 108.3 to the respective intermediate shaft 108 in order to transmit the power received from the engine via gear wheel combination 104.3 and 108.3 to the intermediate shaft 108, as indicated by the block arrows in FIG. 6f.

It is noted that the same feature of locking an intermediate shaft may also be employed in a similar fashion with the transmissions 200 and 300 hereinabove.

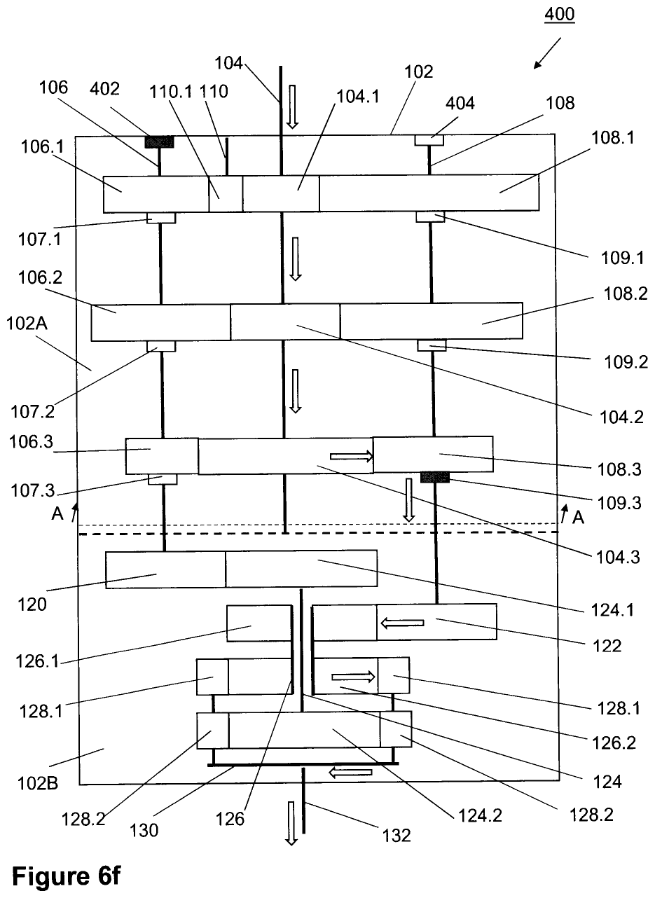

Depending on desired gear ratios and size restrictions of the transmissions 100, 200, 300, and 400 the input shaft 104 and the intermediate shafts 106 and 108 may be placed in a same plane 140, as illustrated in FIG. 7a, or the input shaft 104 may be placed at a predetermined distance D to the plane 140 through the intermediate shafts 106 and 108, as illustrated in FIG. 7b.

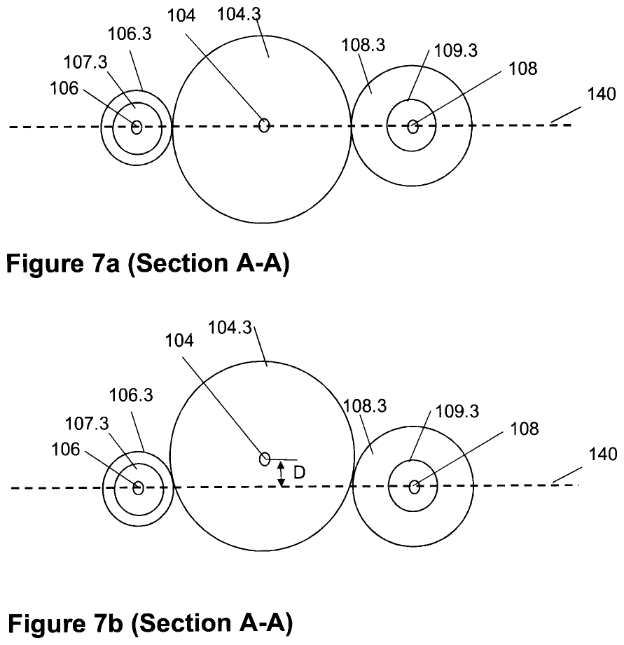

Referring to FIG. 8, a transmission 500 according to another embodiment of the invention is provided. Same reference numerals are used to refer to same components as in the transmission 100. The transmission 500, as illustrated, is similar to the transmission 100 but comprises a third intermediate shaft 502 with intermediate gear wheels disposed there along and associated with respective input gear wheels (only intermediate gear wheel 502.3 and clutch 503.3 shown). In order to combine the output of the three intermediate shafts a second averaging differential is employed in a serial manner for combining the output of shaft 132 with the output of the intermediate shaft 502. Adding the third intermediate shaft, while increasing the size and complexity of the transmission, substantially increases the number of different gear ratios from 3×3=9 to 3×3×3=27.

It is noted that the same feature of providing a third intermediate shaft may also be employed in a similar fashion with the transmissions 200, 300, and 400 hereinabove.

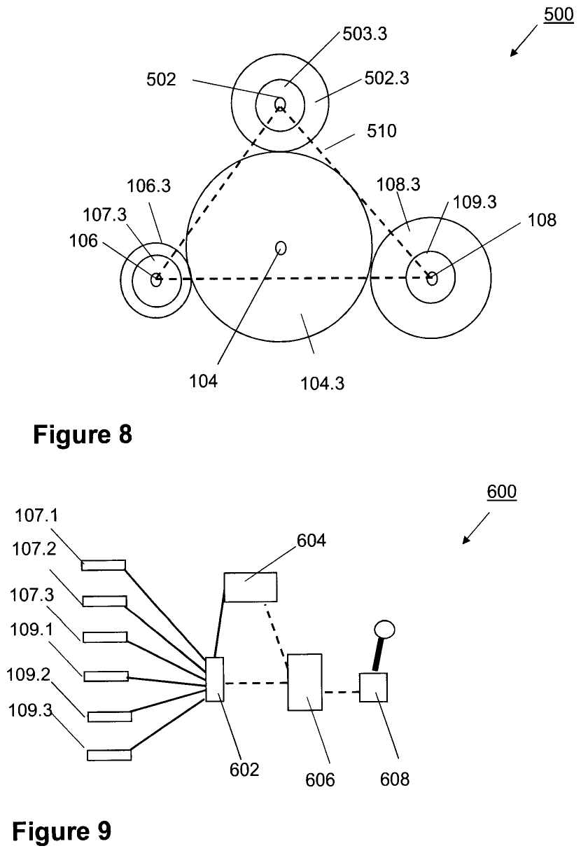

Referring to FIG. 9, a transmission control system 600 according to an embodiment of the invention is provided. The hydraulically operated clutches 107.1, 107.2, 107.3, 109.1, 109.2, and 109.3 are connected to electronically controlled solenoid manifold 602. The clutches 107.1, 107.2, 107.3, 109.1, 109.2, and 109.3 are selectively activated by providing hydraulic pressure from the hydraulic pump 604 via the solenoid manifold 602 in dependence upon an electronic signal received from transmission computer 606. For example, the transmission computer 606 receives an operator initiated signal from gear selector 608, determines the clutch combination to achieve the operator selected gear ratio, and sends a control signal to the respective solenoids of the solenoid manifold 602 for activating the respective clutches. Alternatively, the gear selection is performed by the transmission computer in dependence upon signals received from sensors for sensing, for example, throttle position, RPM, speed, steering angle, and braking. It is noted that while the transmission control system 600 is described with respect to the transmission 100, the system 600 is adaptable for also controlling the transmissions 200 to 500.

The transmissions 100 to 500 provide a large number of gear ratios combined with fast shifting between different gear ratios. Furthermore, the transmissions 100 to 500 enable implementation of high gear ratios such as, for example, 50:1, while conventional transmissions are typically limited to maximum gear ratios of approximately 7:1. Employment of technology used in conventional manual transmissions provides a simple, robust, and cost effective transmission.

It is noted that while the transmissions 100 to 500 as described hereinabove having three gear wheels on each intermediate shaft, the same are not limited thereto but may comprise other numbers of gear wheels such as, for example, 2, 4, or 5.

Reverse motion is achieved by engaging a high ratio reverse gear wheel combination and a lower ratio forward gear wheel combination. Furthermore, forward motion can also be achieved by engaging the reverse gear wheel combination and a forward gear wheel combination.

The present invention has been described herein with regard to certain embodiments. However, it will be obvious to persons skilled in the art that a number of variations and modifications can be made without departing from the scope of the invention as described herein.

What is claimed is:

1. A transmission comprising:
an input shaft for being connected to an engine for receiving power therefrom;
at least two input gear wheels disposed along the input shaft;
at least two intermediate shafts;
at least two intermediate gear wheels disposed along each of the intermediate shafts such that each input gear wheel is associated with a respective intermediate gear wheel;
a clutch system for selectively activating input-intermediate gear wheel combinations for transmitting the power such that at least one of the input gear wheels and at least one intermediate gear wheel is activated; and,
an averaging differential connected to the intermediate shafts and to an output shaft, the averaging differential for combining the power received from the intermediate shafts and providing the same to the output shaft.

2. The transmission according to claim 1 wherein the clutch system comprises a clutch interposed between each intermediate gear wheel and the respective intermediate shaft.

3. The transmission according to claim 1 wherein the clutch system comprises a clutch interposed between each input gear wheel and the input shaft.

4. The transmission according to claim 1 wherein the clutch system comprises a clutch interposed between each input gear wheel of a predetermined subset of input gear wheels and the input shaft and a clutch interposed between each intermediate gear wheel of a predetermined subset of intermediate gear wheels and the respective intermediate shaft with each intermediate gear wheel being associated with a respective input gear wheel other than an input gear wheel of the subset of input gear wheels.

5. The transmission according to claim 1 wherein the transmission comprises two intermediate shafts.

6. The transmission according to claim 1 wherein the transmission comprises three intermediate shafts.

7. A method for selectively transmitting power comprising:
receiving the power from an engine at an input shaft;
selectively transmitting the power to at least two intermediate shafts;
using an averaging differential connected to the intermediate shafts and to an output shaft combining the power received from the intermediate shafts and providing the same to the output shaft.

8. The method according to claim 7 wherein the power is transmitted to the intermediate shafts in forward ratios and wherein the combined power is provided to the output shaft in forward direction.

9. The method according to claim 7 wherein the power is transmitted to the intermediate shafts in reverse and forward ratios and wherein the combined power is provided to the output shaft in reverse direction.

10. The method according to claim 7 wherein the power is transmitted to the intermediate shafts in reverse and forward ratios and wherein the combined power is provided to the output shaft forward direction.
